(19) United States
(12) Patent Application Publication
(10) Pub. No.: US 2018/0234607 A1
(43) Pub. Date: Aug. 16, 2018

(54) BACKGROUND LIGHT ENHANCING APPARATUS RESPONSIVE TO A LOCAL CAMERA OUTPUT VIDEO SIGNAL

(71) Applicant: THOMSON LICENSING, Issy-les-Moulineaux (FR)

(72) Inventors: Anton Werner KELLER, Arni (CH); Fabian Schlumberger, Schwerzenbach (CH)

(21) Appl. No.: 15/513,809

(22) PCT Filed: Sep. 2, 2015
(86) PCT No.: PCT/EP2015/070051

§ 371 Date: Mar. 23, 2017

Related U.S. Application Data
(60) Provisional application No. 62/054,710, filed on Sep. 24, 2014.

(51) Int. Cl. H04N 5/235; H04N 5/232; G06K 9/00; G09G 5/02

(52) U.S. Cl. CPC H04N 5/2354; H04N 5/2351; H04N 5/23206; G06K 9/00255; G09G 2320/0673; G09G 5/02; G09G 2320/0242; G09G 2320/0666; H04N 5/23219

(57) ABSTRACT

A camera of a smart phone used by a first participant in a videoconference generates a video signal containing an image of a first participant. The video signal is transmitted via a communication network. A video processor of the smart phone is responsive to an input video signal received via the communication network for generating a first display drive video signal containing an image of a remote, second participant. The video processor of the smart phone valuates brightness content of the camera generated video signal and generates a second display drive video signal having brightness content that is regulated in a feedback manner to enhance background lighting.

### CROSS REFERENCES

This application claims priority to a U.S. Provisional Application, Ser. No. 62/054,710, filed on Sep. 24, 2014, which is herein incorporated by reference in its entirety.

### FIELD OF THE INVENTION

The present invention is directed to video telephony and, in particular, to an arrangement for enhancing light conditions to which a participant in a video conference is exposed.

### BACKGROUND OF THE INVENTION

Videoconferencing using, for example, Skype or Facetime has become a common tool in the home environment. In a video conference, video cameras are used to allow participants at remote endpoints to view and hear each other. When a participant is exposed to insufficient light condition, the image of the participant displayed at the receiving end may be of low quality. It may be desirable to utilize the light produced in a display screen for illuminating or lightening up a head/face of a participant in the videoconference. A first participant and a remote second participant may participate in the video conference.

In an advantageous embodiment, a camera of a videotelephony device, for example, a smart phone, a television receiver, a personal computer or a tablet, is used by first participant and, for example, a remote second participant that may participate in the video conference. The camera generates a video signal containing a camera captured image, for example, of the face of the first participant. A video processor used in the first participant videotelephony device is responsive to the camera generated video signal for valuating illumination, for example, brightness content of the camera generated video signal. The video processor also generates a first display drive video signal that is displayed in a first region of a display panel of the first participant videotelephony device. The first display drive video signal has brightness content that is regulated in a feedback manner in accordance with the valuated brightness content of the camera generated video signal. The first display drive video signal enhances background lighting produced in the first region of the display panel to enhance the lighting to which an object of the camera, for example, the face of the first participant, is exposed.

The video processor additionally generates a transmitter drive video signal containing the brightness enhanced camera generated image of, for example, the face of the first participant. The image is transmitted via a communication network, and adapted to be received by a videotelephony device of the remote, second participant and to be displayed in a display panel of the second participant videotelephony device.

A second region of the first participant display panel is used for displaying, for example, an image of the face of the remote, second participant contained in an input video signal generated in the videotelephony device of the remote second participant and received via the communication network by the video processor of the videotelephony device of the first participant.

### SUMMARY OF THE INVENTION

A video communication apparatus for employing an advantageous method includes an interface for receiving a video signal that can be generated by a first camera and containing a first image that can be captured in the camera. A video processor configured to valuate illumination content of the first video signal generates a first display drive video signal that is capable of being displayed in a first region of a first display panel to generate background light capable of illuminating an object of the first camera and having illumination content that is regulated, in accordance with illumination content of the first video signal. The video processor is additionally configured to apply the first video signal for transmission in a communication network capable of being displayed in a second display panel, when received from the communication network. The video processor is further configured to receive an input video signal containing a second image from the communication network for generating a second display drive video signal containing the second image that is capable of being reproduced in a second region of the first display panel that is at least partially non-overlapping with the first region.

### BRIEF DESCRIPTION OF THE DRAWINGS

FIG. 1A illustrates a block diagram of a phone, for example, a prior art phone, used in a video conference;

FIG. 1B illustrates a block diagram of a smart phone, embodying a particularly advantageous feature, operated by a first participant that is engaged in the video-conference with a second participant of FIG. 1A;

FIG. 2A illustrates an image of the second participant of FIG. 1A that is captured in a camera of the participant of FIG. 1A;

FIG. 2B illustrates a display panel of the smart phone of FIG. 1B having a light enhancing region;

FIG. 3 illustrates an image of the first participant of FIG. 1B that is captured in the camera of FIG. 1B;

FIGS. 4A, 4B and 4C illustrate three examples, respectively, of asymmetric lighting of the participant of FIG. 1B;

FIG. 5 illustrates a so called selfie image captured in the camera and displayed in the display of FIG. 1B;

FIG. 6 illustrates a display panel of FIG. 1A having a light enhancing region controlled by the phone of FIG. 1B; and

FIG. 7 illustrates asymmetric lighting of the participant of FIG. 1A controlled by the phone of FIG. 1B.

### DETAILED DESCRIPTION

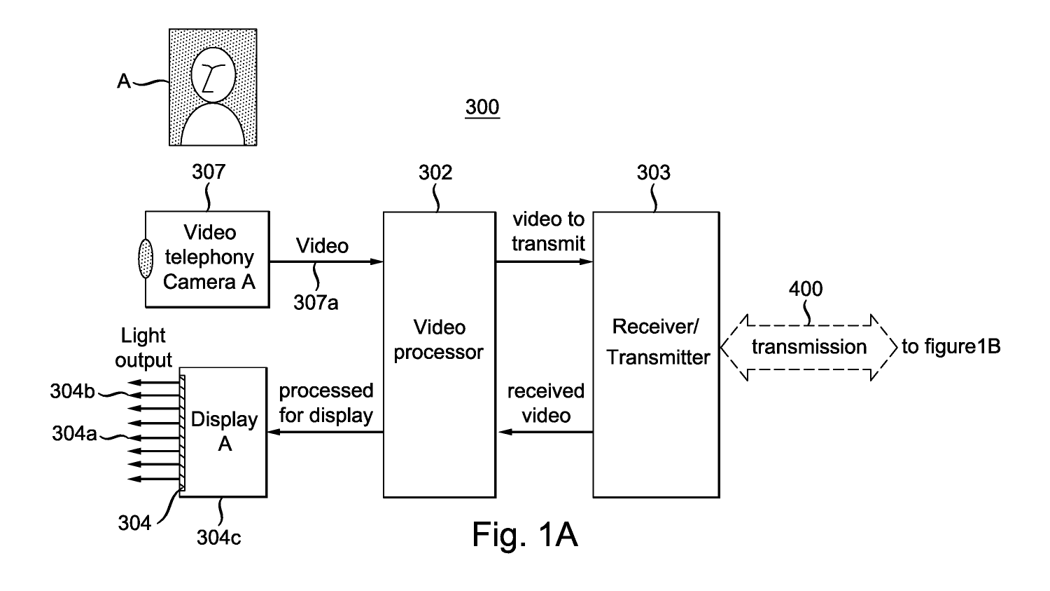

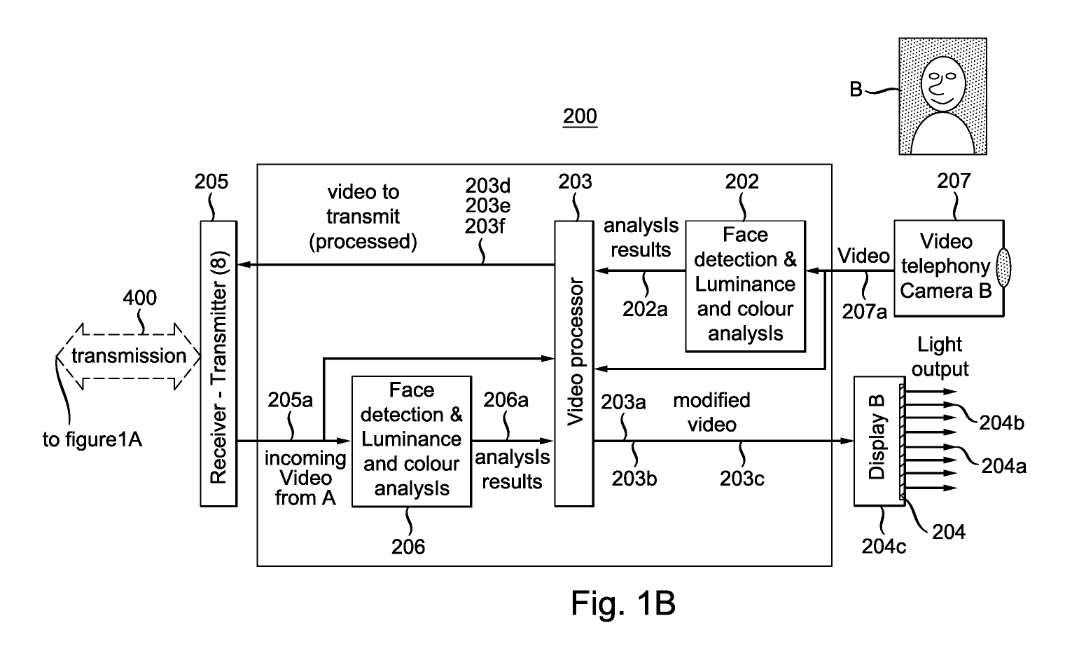

FIG. 1A illustrates a block diagram of, for example, a prior art smart phone 300 operated by a participant A that is engaged in a video-conference with a participant B of FIG. 1B located, for example, remotely from participant B. FIG. 1B illustrates a block diagram of a smart phone 200, providing a particularly advantageous feature, and operated by participant B. Similar symbols and numerals in FIGS. 1A and 1B indicate similar items or functions.

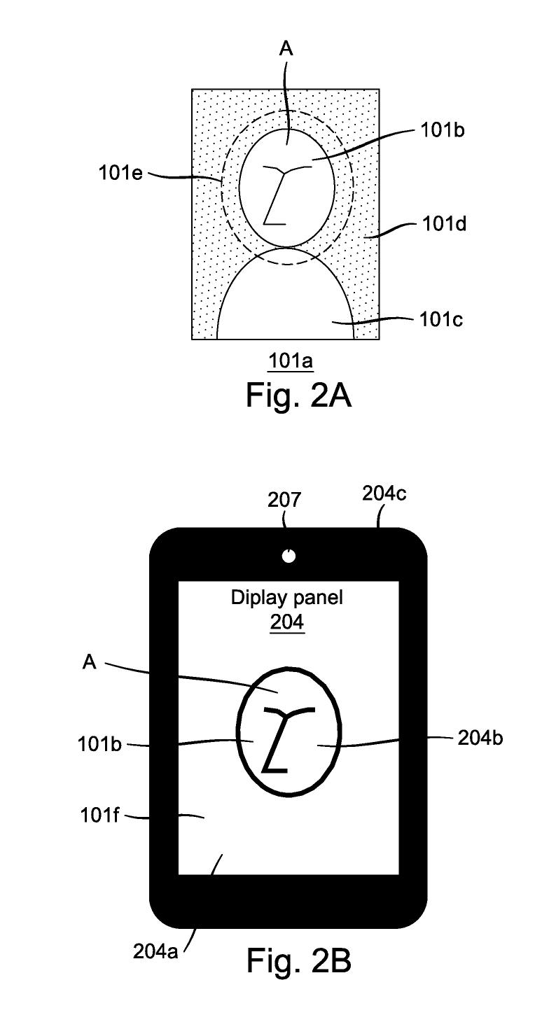

FIG. 2A illustrates an image 101a of participant A of FIG. 1A that is captured in a camera 307 of phone 300 for producing a video signal 307a containing captured image 101a of FIG. 2A. Image 101a includes an image portion 101b depicting a head/face of participant A, an image portion 101c depicting a body of participant A and a background portion 101d that excludes the other two image portions. Similar symbols and numerals in FIGS. 1A, 1B and 2A indicate similar items or functions.

Video signal 307a of FIG. 1A is coupled substantially without video content or picture image modification via a conventional video processor 302, implemented in, for example, a microprocessor, not shown, to a conventional receiver-transmitter stage 303 of phone 300. Receiver-transmitter stage 303 of video processor 302 transmits the content of video signal 307a in a conventional manner via a phone or data/internet communication network 400. A conventional receiver-transmitter stage 205 of FIG. 1B receives via network 400 the signal transmitted by receiver-transmitter stage 303 of FIG. 1A that contains image 101a of FIG. 2A forming an input video signal 205a of FIG. 1B. Input video signal 205a contains the same video or picture content as image 101a of FIG. 2A. Advantageously, a video processor 206 of FIG. 1B, implemented in, for example, a microprocessor, not shown, detects or recognizes in input video signal 205a a portion signal, not shown, forming an image portion 101b of FIG. 2A depicting the head/face image of participant A of FIG. 1A using well known pattern recognition technique. Alternatively, the detected or recognized portion may also include a band 101e of what would be otherwise background portion 101d, in addition to the signal portion associated with head/face image portion 101b. Detecting or recognizing the head/face contained in image portion 101b is performed using a method similar to recognition methods explained, for example, in U.S. Pat. No. 6,661,907, in U.S. Pat. No. 6,343,141 and in an article, entitled, “Detecting Faces in Images: A Survey” by IEEE TRANSACTIONS ON PATTERN ANALYSIS AND MACHINE INTELLIGENCE, VOL. 24, NO. 1, JANUARY 2002.

The aforementioned portion, not shown, of video signal 205a that contains head/face image portion 101b of FIG. 2A of participant A is extracted and applied in a video processor 203 to generate a display drive video signal 203b. In addition, video processor 203 of FIG. 1B synthesizes a display drive video signal 203c that is combined with display drive video signal 203b to form a combined display drive video signal 203a. Thus, signal 203a contains both display drive video signals 203c and 203b. Display drive video signals 203c and 203b are applied to a conventional display device 204c having a display panel 204. In display panel 204, display drive video signal 203b produces in a region 204b of display panel 204 of FIG. 2B an image portion having, for example, the same picture image content as head/face image portion 101b of FIG. 2A and is referred to in FIG. 2B using the same symbol 101b. Similar symbols and numerals in FIGS. 1A, 1B, 2A and 2B indicate similar items or functions.

In a particularly advantageous arrangement, synthesized display drive video signal 203c of FIG. 1B produces light in a region 204a of display panel 204 of FIG. 2B that excludes head/face image portion 101b and is non-overlapping with region 204b of display panel 204. Light producing region 204a is used for generating and regulating illumination in region 204a to lighten up, for example, the head/face of participant B forming the object of a camera 207.

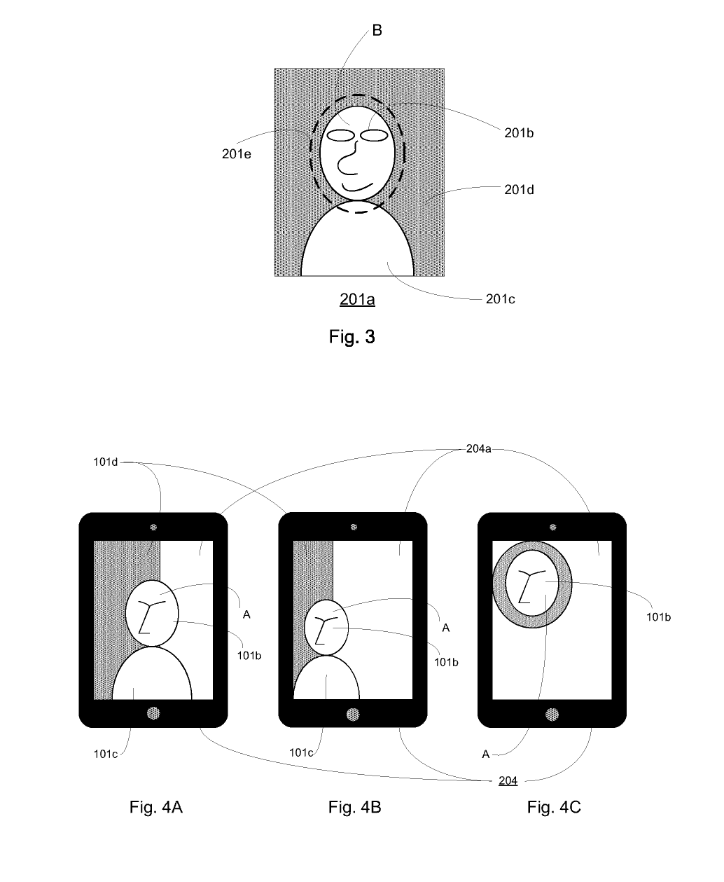

FIG. 3 illustrates an image 201a captured in camera 207 of FIG. 1B of participant B forming the object of camera 207. Similar symbols and numerals in FIGS. 1A, 1B, 2A, 2B and 3 indicate similar items or functions.

Image 201a of FIG. 3 depicts a head/face image portion 201b of participant B, a body image portion 201c of participant B and a background image portion 201d that excludes at least head/face image portion 201b of participant B. A video signal 207a of FIG. 1B contains image 201a of FIG. 3. Video signal 207a of FIG. 1B is processed in a video processor 202 implemented in, for example, the same microprocessor, not shown, which also implements processors 203 and 206 that were mentioned before. Thus, video processor 202, video processor 203 and video processor 206 may be combined to form a single video processor 250.

In a particularly advantageous arrangement, video processor 202, using a pattern recognition technique referred to before, detects or recognizes and extracts a signal portion, not shown, of video signal 207a that contains the image pattern of head/face image portion 201b of FIG. 3 of participant B of FIG. 1B to the exclusion of the rest of image 201a. Optionally, the video content of a band portion 201e may also be included in the detected and extracted portion.

In a particularly advantageous arrangement, video processor 202 of FIG. 1B valuates illumination exposure parameter, for example, brightness, signal-to-noise ratio content of captured image 201a or other optical characteristics of captured image 201a of FIG. 3 such as color, or a combination thereof, by analyzing the detected and extracted portion, not shown, of video signal 207a of FIG. 1B that contains head/face image portion 201b of FIG. 3. Alternatively, the combination of head/face image portion 201b and, for example, band 101e can be used for such valuation. Illumination or brightness valuation applies well known pixel signal integration processes.

In one alternative, the integration process is applied to captured image 201a of participant B of FIG. 3 in its entirety. In other alternatives, the integration process is applied solely to head/face image portion 201b or to a combination of head/face image portion 201b and portion 201e of captured image 201a of participant B of FIG. 1B. An output signal 202a of processor 202 contains a value indicative of the illumination such as the aforementioned brightness content exposure of the image of participant B.

The valuation may indicates that the illumination of head/face image portion 201b of FIG. 3 is insufficiently low to be below a threshold level. In a particularly advantageous arrangement, a combination of the brightness content, color content and gamma correction values contained in display drive video signal 203c, that excludes the content of image of head/face image portion 101b of FIG. 2A, is regulated in, for example, a closed loop negative feedback manner. The regulation is performed in accordance with the valuated illumination/brightness content in signal 202a of FIG. 1B. As a result, illumination of light producing region 204a of FIG. 2B that excludes region 204b is controlled in a manner to vary the light exposure to which the object of camera 207 of FIG. 1B such as the head/face of participant B. The illumination of light producing region 204a of FIG. 2B is obtained for enhancing the overall illumination or brightness content, contrast and/or color temperature in a closed loop negative feedback manner. Whenever the lighting circumstances change, adaptive sense signal 202a also changes. The brightness and/or color content of light producing region 204a of FIG. 2B might be increased up to attain white color with maximum light output.

The regulated light output can be controlled by, for example, controlling light valves or cells, not shown, forming pixels of display panel 204 that may be formed using, for example, liquid crystal display (LCD) or organic light-emitting diode (OLED) technology. When, for example, the LCD technology is used, the regulated light output may be additionally or alternatively controlled by selectively controlling back lighting, not shown, of display panel 204. Advantageously, an improved or better lighted head/face image portion 201b of participant B of FIG. 1B is thereby obtained. For example, if participant B is located in a dark room and an exterior lighting, not shown, directed towards the head/face of participant B is poor, the brightness content of light producing region 204a of FIG. 2B is increased in a negative feedback manner to an optimal value for obtaining enhanced illumination of the head/face of participant B of FIG. 3. The result is that signal 207a of camera 207 of FIG. 1B will contain image 201a of participant B of FIG. 3 that is, advantageously, optimally brighter.

In one example, Signal 207a of camera 207 of FIG. 1B is applied in video processor 203 to transmitter-receiver stage 205 that transmits via communication network 400 a transmitter drive video signal 203d of processor 203 containing image 201a of FIG. 3. At a remote end, receiver-transmitter stage 303 of FIG. 1A receives transmitted drive video signal 203d and displays it, for example, unmodified, in a display panel 304 of a display device 304c of phone 300.

The enhanced lighting conditions produced in light producing region 204a of FIG. 2B, controlled by the negative feedback control loop, cause image 201a of FIG. 3 to be, advantageously, optimally bright when displayed in display panel 304 of FIG. 1A of participant A. Thus, advantageously, even prior art phone 300 benefits from the advantageous features of advantageous phone 200 of FIG. 1B.

Advantageously, the color temperature of, in particular, the skin of the image of participant B of FIG. 1B may be analyzed by processor 202. As explained before, processor 203 can vary the color of light producing region 204a of FIG. 2B in accordance with the analysis results of processor 202 of FIG. 1B. The result is that image 201a of participant B of FIG. 3 that is transmitted to participant A of FIG. 1A can become, advantageously, more presentable or so-called healthier looking. If the object of camera 207 of FIG. 1B includes more than one person, for example, a family, resulting in more than a single head/face in the picture, each head/face can be detected or recognized and taken into account to be displayed in a similar manner described before with respect to single participant B.

Advantageously, to alleviate partial exposure to light, an under-exposed head/face portion may be selectively lightened up by light producing region 204a of display 204 to illuminate mainly the darker side in an asymmetric manner. Partial exposure occurs when only one portion of the image is poorly lighted as a result of, for example, an external light source, not shown, such as a lamp that illuminates mainly one side of the face of participant B. FIGS. 4A, 4B and 4C illustrate three examples of such so-called asymmetric lighting. Similar symbols and numerals in FIGS. 1A, 1B, 2A, 2B, 3, 4A, 4B and 4C indicate similar items or functions.

In FIGS. 4A and 4B, light producing region 204a occupies only a right portion of display panel 204 for producing light output at the right side of the image of participant A that is directed to the head/face of participant B of FIG. 1B. In the example of FIG. 4B, the proportional size of head/face portion 101b is scaled down and relocated to the left and down. Whereas, the area of light producing region 204a becomes proportionally larger than in FIG. 4A to allow for better asymmetrical lighting.

In FIG. 4C, head/face image portion 101b is relocated to one corner or side allowing the rest of the area for producing more light output at the lower and right sides of head/face portion 101b that is directed to the head/face of participant B of FIG. 1B. The size of the area occupied by light producing region 204a of FIGS. 4A, 4B and 4C is regulated by processor 203 of FIG. 1B in accordance with valuated illumination distribution content in head/face image portion 201b of FIG. 3.

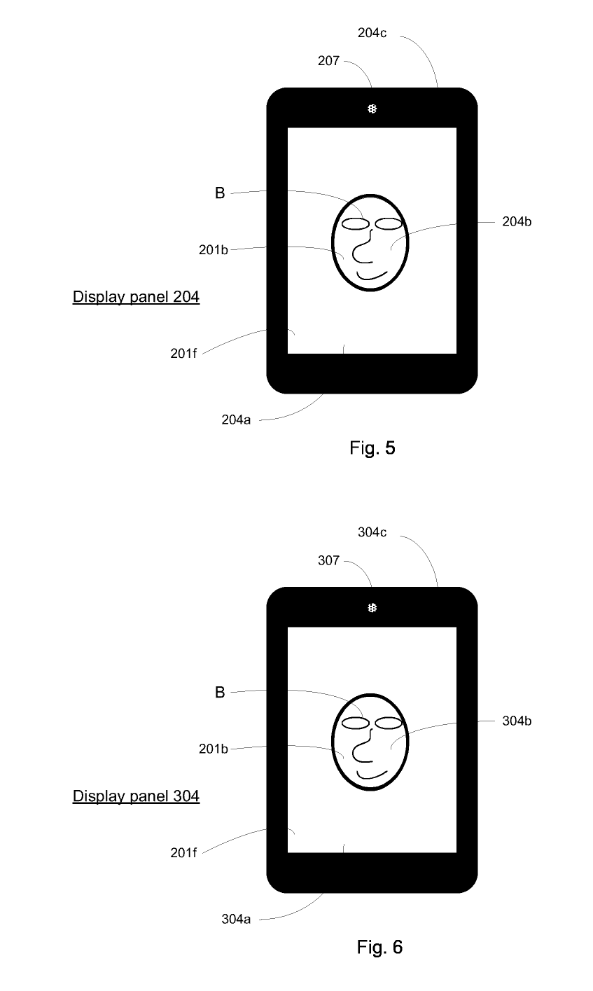

In a particularly advantageous arrangement, phone 200 of FIG. 1B is also capable of providing enhanced lighting content of head/face image portion 201b of FIG. 3 of participant B of FIG. 1B also when camera 207 is used, in a manner unrelated to video telephony, to capture and store, for example, a self-portrait photograph referred to as selfie. For this purpose, the portion, not shown, of video signal 207a that contains mainly head/face image portion 201b of FIG. 3 of participant B is extracted and applied in video processor 203 to generate display drive video signal 203b of display drive output video signal 203a of video processor 203. This is done in an analogous manner described before with respect to FIG. 2B. A main difference is that, instead of displaying head/face image portion 101b of participant A in display panel 204 of FIG. 2B, display drive video signal 203b contains mainly the extracted head/face image portion 201b of participant B of FIG. 3 for display in display panel 204 of FIG. 5. Similar symbols and numerals in FIGS. 1A, 1B, 2A, 2B, 3, 4A, 4B, 4C and 5 indicate similar items or functions. In this way, participant B can view his head/face image portion 201b captured by camera 207 of FIG. 1B.

If the aforementioned content illumination valuation performed in processor 202 indicates that the brightness values of head/face image portion 201b of FIG. 3 is insufficiently low, a combination of the brightness content, color content and gamma correction values associated with display drive video signal 203c is regulated in, for example, a closed loop negative feedback manner. The regulation is performed in accordance with the illumination/brightness content in signal 202a of FIG. 1B. The illumination of light producing region 204a of FIG. 5 is controlled in a manner to vary the light exposure to which the selfie picture taker B is subjected in a manner to enhance the overall brightness content, contrast and color temperature in a closed loop feedback manner. It should be understood that the advantageous features described before in connection with FIG. 2B and FIGS. 4A-4C are also applicable in an analogous manner with respect to capturing and storing a selfie.

As explained before, when participants A and B of FIGS. 1A and 1B, respectively, participate in a videotelephony conference, a portion, not shown, of video signal 207a that contains head/face image portion 201b of FIG. 3 of participant B is extracted and applied in video processor 203 of FIG. 1B to generate a transmitter drive output video signal 203e. Transmitter drive output video signal 203e is contained in the aforementioned transmitter drive output video signal 203d. Transmitter drive video signal 203e has, for example, substantially the same visual content as the aforementioned extracted portion signal containing just head/face image portion 201b of FIG. 3 of participant B of FIG. 1B. In addition, video processor 203 of FIG. 1B synthesizes a transmitter drive video signal 203f that is also contained in signal 203d. Thus, signal 203d that contains both signals 203e and 203f is applied to receiver-transmitter stage 205 that transmits signal 203d via network 400. Receiver-transmitter stage 303 of FIG. 1A that receives signal 203d via network 400 displays it, for example, without modifying its visual contents, in display panel 304 of FIG. 6 of phone 300 of FIG. 1A. Similar symbols and numerals in FIGS. 1A, 1B, 2A, 2B, 3, 4A, 4B, 4C, 5 and 6 indicate similar items or functions. In display panel 304 of FIG. 6, display drive video signal 203e produces an image portion having, for example, the same visual content as the head/face image portion 201b of FIG. 3 for display in a display region 304b of display panel 304 of FIG. 6.

Video processor 206 of FIG. 1B, for example, in addition to extracting head/face image portion 101b of FIG. 2A for display in display panel 204 of FIG. 1B, in the manner described before, also valuates the illumination exposure of image 101a of FIG. 2A received from participant A of FIG. 1A. Optionally, video processor 206 of FIG. 1B also valuates other optical characteristics such as color of image 101a of FIG. 2A contained in video signal 205a of FIG. 1B. Such valuation applies well known pixel signal integration processes in the manner described before with respect to head/face image portion 201b of FIG. 3.

In one alternative, an integration process is applied to the content of captured image 101a of participant A of FIG. 2A in its entirety. In other alternatives, video processor 206 of Figure B detects or recognizes the pattern of head/face image portion 101b of FIG. 2A. Then, the integration process is applied solely to the portion of signal 205a of FIG. 1B that corresponds to head/face image portion 101b of FIG. 2A or to a combination of image portion 101b and portion 101e of captured image 101a of participant A. The result of such valuation is contained in an output signal 206a of processor 206 containing brightness values indicative of the extent of illumination exposure on head/face image portion 101b of FIG. 2A of participant A.

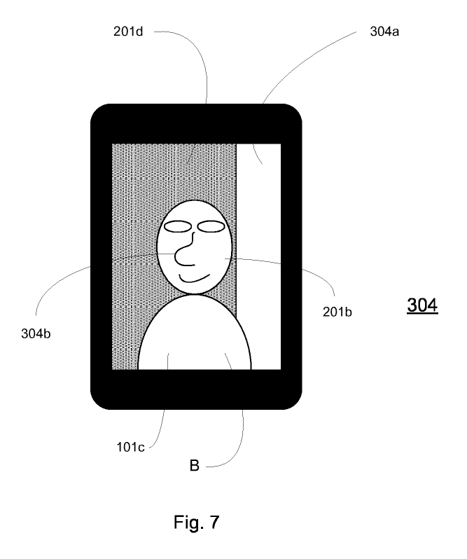

Advantageously, if the analysis of the content of signal 206a of FIG. 1B indicates that the illumination/brightness content valuation associated with the image of participant A of FIG. 2A is insufficiently low, for example, below a threshold level, video processor 203 of FIG. 1B synthesizes transmitter drive video signal 203f in a manner to produce light in a region 304a of FIG. 6 of display panel 304 of FIG. 1B. Region 304a of FIG. 6 excludes head/face image portion 201b of region 304b and is non-overlapping with region 304b of display panel 304. Light producing region 304a is used for generating and regulating in a negative feedback manner illumination in region 304a to lighten up, for example, the head/face of participant A of FIG. 1A forming the object of camera 307. This is done, advantageously, for controlling illumination such as brightness content directed to the head/face of participant A of FIG. 1A in an analogous manner by which illumination producing region 204a of FIG. 2B is lightened up. Thus, the illumination of light producing region 304a of FIG. 6 may be controlled to vary the light exposure on participant A of FIG. 1A in a manner to enhance the overall brightness content, contrast content and/or color temperature in a closed loop negative feedback manner. Whenever the lighting circumstances change, correction signal 206a of FIG. 1B is adaptive to that change. The brightness content of light producing region 304a of FIG. 6 might be increased up to optimal light output. In an analogous way to the way described before with respect to FIGS. 4A, 4B and 4C, the head/face of participant A may be lightened up by light producing region 304a of display panel 304 that illuminates a darker side of head/face image portion 201b of FIG. 7 in an asymmetric manner. Similar symbols and numerals in FIGS. 1A, 1B, 2A, 2B, 3, 4A, 4B, 4C, 5, 6 and 7 indicate similar items or functions.

1. A video communication apparatus, comprising:
an interface configured to receive a first video signal generated by a camera of a first image of an object captured by said camera; and
a video processor configured to valuate illumination content of said first video signal to generate a first display drive video signal to be displayed in a first region of a first display panel to control background light applied to said object,
wherein said video processor is further configured to display said received first video signal in a second display panel via a communication network,
said video processor being further configured to receive a second video signal from said communication network containing a second image and generate a second display drive video signal to display said second image in a second region of said first display panel.

2. The video communication apparatus according to claim 1 wherein a first and a second portion of said second image are selected using an image recognition technique, the first portion being displayed in said second region of said first display panel and the second portion being excluded from displaying in said second region of said first display panel.

3. The video communication apparatus according to claim 2 wherein said first portion comprises a head/face image contained in said second video signal.

4. The video communication apparatus according to claim 1 wherein said video processor is responsive to received first video signal for generating said first display drive video signal having color content that is regulated in accordance with color content of said first video signal.

5. The video communication apparatus according to claim 1 wherein said video processor generates said first display drive video signal in accordance with brightness content of a portion of said first video signal.

6. The video communication apparatus according to claim 1 wherein said video processor recognizes a particular image in said first video signal for generating an output transmitter drive video signal that includes, in accordance with said recognized particular image, a first portion of said first image contained in said first video signal and that excludes, in accordance with said recognized particular image, a second portion of said first image.

7. The video communication apparatus according to claim 1 wherein the illumination content of said second display drive video signal is substantially unaffected by said video processor.

8. The video communication apparatus according to claim 1 wherein said communication network comprises one of the Internet, a data network and a telephone network.

9. The video communication apparatus, according to claim 1, wherein said video processor generates a first output transmitter drive video signal for transmission in said communication network having illumination content that is controlled in accordance with illumination content of said second image, said first output transmitter drive video signal being capable, when received from said communication network, of generating in a first region of a second display panel background light that is regulated, and wherein said video processor generates a second output transmitter drive video signal containing said
first image for transmission in said communication network and that is capable of being displayed, when received from said communication network, in a second region of said second display panel.

10. The video communication apparatus according to claim 1 wherein said video processor varies, in accordance with brightness content of said first camera generated video signal, at least one of a size of said first region of said first display panel, a size of said second region of said first display panel, a location of said first region of said first display panel and a location of said second region of said first display panel.

11. The video communication apparatus according to claim 1, further comprising said camera that generates said first video signal containing said first image and said first display panel for displaying said first display drive video signal in said first region of said first display panel and said second display drive video signal in said second region of said first display panel.

12. A method for performing video communication, comprising:
generating a first video signal containing a first image captured by a first camera;
valuating illumination content of said first video signal;
generating a first display drive video signal to be displayed in a first region of a first display panel to control background light of an object of said first image;
transmitting image information contained in said first video signal in a communication network to be displayed in a second display panel, when received from the communication network;
receiving a second video signal from the communication network containing a second image;
generating a second display drive video signal containing said second image that to be displayed in a second region of said first display panel.

13. The method for performing video communication according to claim 12, further comprising generating said second display drive video signal to contain a first portion of said second image and to exclude a second portion of said second image, said first and second portion being selected using an image recognition technique.

14. The method for performing video communication according to claim 13 wherein said first portion comprises a head/face image contained in said second video signal.

15. The method for performing video communication according to claim 12 wherein said first display drive video signal is generated to have color content that is regulated in accordance with color content of said camera generated video signal.

16. The method for performing video communication according to claim 12 wherein said first display drive video signal is generated in accordance with brightness content of a portion of said camera generated video signal.

17. The method for performing video communication according to claim 12 further comprising, recognizing a particular image in said first video signal and, in accordance with the particular image recognition, generating an output transmitter drive video signal for transmission in said communication network that is configured to contain a first portion of said first image contained in said first video signal and to exclude a second portion of said first image.

18. The method for performing video communication according to claim 12 wherein the illumination content of said second display drive video signal is substantially unaffected by said video processor.

19. The method for performing video communication according to claim 12 wherein said communication network comprises one of the Internet, a data network and a telephone network.

20. A video camera apparatus, comprising:
an interface for receiving a first video signal and containing an image that can be captured in a camera; and
a video processor configured to valuate illumination content of said first video signal for generating a first display drive video signal that can be applied to a first region of a first display panel to generate background light capable of illuminating an object of said camera and having illumination content that is regulated, in accordance with illumination content of said first video signal, said video processor being further configured to generate a second display drive video signal containing said image that is capable of being reproduced in a second region of said display panel that excludes said first region.
